(19) United States
(12) Patent Application Publication
(10) Pub. No.: US 2022/0412574 A1
(43) Pub. Date: Dec. 29, 2022

(54) MODULE AND SYSTEM FOR SOLAR-ELECTRIC HEATING OF FLUIDS

(71) Applicants: Dekel Keisar, Tel Aviv (IL); Lihy Schwarzmann, Tel Aviv (IL); Shai Haklai, Pardesia (IL); Dror Shlomo Medini, Kadima (IL)

(72) Inventors: Dekel Keisar, Tel Aviv (IL); Lihy Schwarzmann, Tel Aviv (IL); Shai Haklai, Pardesia (IL); Dror Shlomo Medini, Kadima (IL)

(21) Appl. No.: 17/787,638

(22) PCT Filed: Dec. 29, 2020
(86) PCT No.: PCT/IL2020/051340

§ 371 Date: Jun. 21, 2022

(30) Foreign Application Priority Data
Dec. 30, 2019 (IL) 271773

(51) Int. Cl. F24D 3/00; F24D 13/02

(52) U.S. Cl. CPC F24D 3/005; F24D 13/02; F24D 2200/02; F24D 2200/08

(57) ABSTRACT

A water heating solar module designed for being connected to a boiler of a water heating system, the module comprises a vessel having a water inlet and a water outlet, a first heating element installed in the vessel, and a power supply for feeding the first heating element with electric power produced from solar energy. The module is arranged as follows: the vessel is positioned near the boiler, so that the vessel's bottom portion is placed not higher than the boiler's bottom portion; the water inlet is provided at the vessel's bottom portion and is adapted for receiving water from the boiler; the water outlet is provided at the vessel's top portion and is adapted for delivering water from the vessel to the boiler; the power supply is electrically connectable to a photoelectric device for receiving electric energy there-from, and to the first heating element, for heating water in the vessel. The invention also describes a system comprising the described module connected to the mentioned boiler, and a method of upgrading an existing water heating solar system by the described module.

### FIELD OF THE INVENTION

The present invention relates to a technique for heating fluids, for example water, using both electrical and solar energy. More specifically, the technique is intended for designing and installing, in private or public buildings, solar-electric water heating boilers suitable to any weather conditions, including temperatures below 0° C.

### BACKGROUND OF THE INVENTION

There are prior devices and publications describing electrical & solar water heating systems.

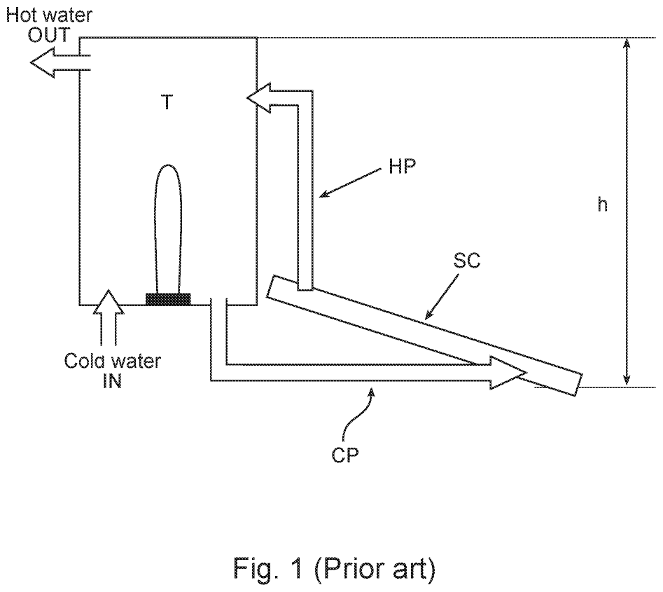

FIG. 1 (prior art) illustrates a basic solution of a regular water heating solar boiler installed on a building's roof. It comprises a water tank T fed by water from some water supply, a solar collector SC and two water circulation pipes—a hot water pipe HP and a cold water pipe CP. Water supply pipe and water delivery pipe are shown as “Cold water IN” and “Hot water OUT”, respectively.

In the device illustrated in FIG. 1, cold water from the tank T continuously flows down through pipe CP to the solar collector SC (where it is heated by sun), the heated water rises through the collector and via the hot water circulation pipe HP and finally returns to the tank T through the hot water pipe HP. The tank's height “h” relative to the roof (usually of about 2 meters) and a specific angle of the solar collector plate allows absorption of sun radiation and circulation of cold and heated water in the system.

The device of FIG. 1 suffers from many disadvantages. The main disadvantage is that during cold seasons, tank T and especially solar collector SC and water pipes HP, CP dissipate a lot of heat energy and may even freeze. Another disadvantage of the device are very considerable heat losses, when supplying the hot water via long water delivery pipes from the tank T to premises located at lower floors of the building.

A major disadvantage of the system that it works as is only if the tank T is positioned above the solar collector SC. If the collector is located differently, a water pump is needed.

Another known concept of a water heating boiler is based on a regular water tank provided with a main electrical heater element, wherein the water in that tank may also be heated by using solar energy.

It should be noted that in regular electric & solar boilers, the regular water tank has not only the main electrical heating element, but also an additional electric heating element which is activated by a solar energy collector (a solar heating system). For example, US20120187106 has one water tank which may utilize both an electric heater and a photovoltaic heater.

It is known that quite often, electricians start repairing a water heating tank after switching OFF the main heating element only, while an additional heating element (if exists in the tank) may remain switched or switchable ON and thus constitutes a high danger to the electrician.

Some known electrical & solar systems comprise two water tanks.

For example, such a concept is presented in CN201233061 and CN101592356 which describe a system where two water tanks are provided with water circulation pipes, and where one of the tanks (the storage tank) is connected to a solar heating device. The other tank is an electrically heated water tank. The system is equipped with a water circulating pump.

Anyway, energy losses in such boilers and their water circulation pipes are quite considerable.

Solar equipment should be placed outdoors (say, on a roof), so water pipes connecting the solar device with the tank will anyway dissipate heat energy.

There is still a long felt need in providing a simple and safe water heating system which would effectively use both electrical and solar energy.

### OBJECT OF THE INVENTION

It is therefore one object of the present invention to overcome the above-mentioned drawbacks and to provide a simple, safe and economic solar-electric system for heating fluids, for example water.

It is another object of the present invention to provide a solar module for fluid/water heating, which would be compatible with already existing solar or electric boilers.

The definitions and the description below will refer to water heating modules and systems, but should be understood as referring to fluids in general while using water as a specific example of fluids.

A specific object would be to provide such a solar module, which could easily and effectively replace a conventional solar collector in existing water heating systems.

Let us start with describing the module of interest proposed by the Inventors.

According to a first aspect of the invention, there is provided a water heating solar module designed for being connected to a boiler of a water heating system, the module comprising at least:

a vessel having a bottom portion, a top portion, a water inlet, a water outlet,

a first heating element installed in the vessel, and

a power supply for feeding the first heating element with electric power produced from solar energy,

wherein
said vessel is designed to be positioned near the boiler, so that the vessel's bottom portion be placed not higher than the boiler's bottom portion,
the water inlet is provided at the vessel's bottom portion and is adapted for receiving water from said boiler,
the water outlet is provided at the vessel's top portion and is adapted for delivering water from the vessel to said boiler,
the power supply is electrically connectable to
   a photoelectric device (for example, one or more solar photovoltaic cells) for receiving electric energy there-from (for example, via electric wires), and
   to the first heating element, for heating water in the vessel.

The photoelectric device may be understood as a general term defining various photoelectric (in this case—solar to electric) convertors. Such a device may comprise at least one solar photovoltaic cell, but may comprise an array of solar photovoltaic cells. The photoelectric device may be built according to any presently known or future technology ensuring conversion of solar energy into electrical energy.

In one embodiment, the module may be designed so as to be placed completely under a level of the boiler's bottom.

In one specific embodiment, the power supply of the module may comprise an MPPT circuit (Maximum Power Point Tracking circuit) adapted for collecting electric power from the photoelectric device, and for feeding the first heating element with the collected electric power.

More specifically, the Maximum Power Point Tracking circuit may be configured to track the maximum power point of a photovoltaic cell array and to provide that maximum power collectively to the first heating element.

For example, the power supply may be designed so as to receive DC electric power form said one or more photovoltaic cells, and so as to feed the first heating element with DC electric power.

Alternatively or in addition, the power supply may be adapted to convert DC to AC and to feed the first heating element with AC electric power.

Accordingly, the first heating element may be a resistance heater adapted either to DC, or to AC feed. In any case, the first heating element may be called a photovoltaic heating element, since it is fed with electric energy produced from solar power by the photoelectric system, such as the photovoltaic cells or the like.

In various embodiments, the vessel of the module may be manufactured in the form of a tank, a pipe, a pipes assembly, etc.

In a further specific embodiment, the module may additionally comprise a cold water circulation pipe for connecting the water inlet of the vessel with the boiler, and a hot water circulation pipe for connecting the water outlet of the vessel with the boiler.

According to a second aspect of the invention, there is also provided a system for heating water in premises, the system comprising the above-described solar water heating module and the mentioned boiler,

wherein

the module is positioned so that the vessel's lower portion is not higher than the boiler's bottom portion,

the boiler is equipped with a second heating element,

the boiler is provided with four pipes:
an inlet cold water pipe,
an outlet hot water pipe,
a cold water circulation pipe connecting a bottom portion of the boiler with the water inlet of the vessel,
a hot water circulation pipe connecting the water outlet of the vessel with a top portion of the boiler.

The proposed system may be called a two-tank system, since it comprises a main water tank (the boiler) and an additional water tank (vessel of the module) supposed to be heated using solar energy. The additional water tank is in flow communication with the main water tank via at least two mentioned water circulation pipes.

The additional water tank (vessel of the module) may be smaller in volume than the main water tank, and thus may serve for preheating water for the main tank.

In the proposed system, there are two heating elements which are placed in different tanks: the first heating element in the vessel of the module and the second heating element in the boiler. This arrangement is safer for any maintenance works, than arrangements where a tank comprises more than one heating elements.

The first heating element, installed in the vessel, was discussed above with reference to the solar water heating module.

The second heating element installed in the boiler may be a regular electrical heating element fed from the AC grid. However, other options may exist.

The system may further include at least one photovoltaic device (such as a photovoltaic cell), electrically connected to the power supply of the module.

In order to minimize energy losses in the tanks and in the water circulation pipes,
both of the tanks are preferably located within the premises (i.e., under the roof), wherein
said one or more photovoltaic cells are installed outside the premises (for example on the roof), and connected via electric wires to the power supply of the module.

The premises should be understood as a public or private building, apartment, office, hospital, kindergarten, school etc.

Preferably, the two tanks are placed in close proximity to one another to minimize heat dissipation.

The additional water tank (the vessel) may be smaller than the main water tank (the boiler).

Preferably, the additional water tank (the vessel of the module) may be placed at a lower position in respect of the main water tank (the boiler), in order to provide natural flow (i.e., without water pumps) in water circulation pipes between the tanks.

In periods when there is no solar radiation or it is insufficient for heating water, the solar water heating module will remain inactive but will have no effect on the system. In such periods/seasons, the second (main) heating element will heat the water in the main tank, while the additional tank of the module will behave just as a vessel being in flow communication with the main tank.

According to a third aspect of the invention, there is also proposed a method of upgrading an existing solar heating system having a boiler and a solar collector plate, the method comprises:
replacing the solar collector plate with a module (according to the module as described above), while placing the module so that the lower portion of the module's vessel is not higher than the boiler's bottom portion (for example, the module may be mainly positioned under the boiler's bottom),
connecting said module to the boiler by water circulation pipes,
providing a photoelectric device (for example, one or more photovoltaic cells), and
connecting the power supply of said module to the photoelectric device by electric wires.

Advantages of the proposed water heating solar module and the proposed two-tank system are at least the following:
The proposed water heating solar module may replace ineffective water containing solar collectors. Now, such collectors are widely used in Israel, in solar and solar-electric water heating systems. Replacement of the old solar collectors with the proposed module not only improves efficiency of the system, but also allows utilizing available/existing standard tanks, thus allowing inexpensive upgrade of the existing water heating solar and solar-electrical systems.
The technique allows using two standard water tanks with standard electrical heating elements, one of them just being adapted to receive electric energy from the solar converter (e.g., a photovoltaic cell).
The technique allows installing the water tanks at any place in a building, even in the basement, where they will not be affected by weather and will be easily accessible for maintenance and repair.
The technique allows effective use of solar and electric energy, especially in cold countries and/or in cold seasons.

Owing to the proposed arrangement and placement, the described module and system will be protected from negative effects of low outdoors temperature, wind, rain and snow. Indeed, not only the main water tank and the additional water tank are placed inside the building and are protected from heat losses and freezing, but also water circulation pipes, water supply pipes and water delivery pipes will be all placed in the premises and thus be protected from excessive heat dissipation and freezing in winter. We remind that the proposed module (with the vessel/the additional tank), located inside the building, will receive energy from the outside solar system via electric wires, but not via water pipes. The thus heated water will be efficiently conveyed to the main tank (boiler) via water circulation pipes which are all located in the building.
The technique is safer than boilers comprising more than one heating element per tank.

When there is only one heating element in each water tank, there is less danger for technicians, electricians and just for people using the boiler, since any cleaning or maintenance operations will be carried out more safely.

Indeed, it is much safer when the two electric heating elements of the respective two water tanks are electrically separate from one another. Any work to be performed in one of the tanks may be done independently from another tank, just by closing valves in the water pipes and switching OFF electrical circuits of the tank of interest.
The technique does not require a water pump.

Owing to the proposed configuration the proposed system may maintain water circulation without any water pump, just by causing natural convection of cold and warm water via water circulation pipes.

The invention will be described in more detail as the description proceeds.

### BRIEF DESCRIPTION OF PREFERRED EMBODIMENTS

The invention will further be described with reference to the following non-limiting drawings in which:

FIG. 1 (prior art) illustrates a regular solar boiler.

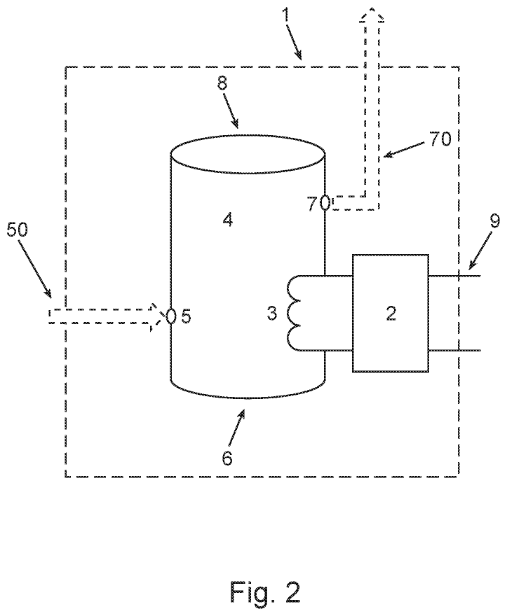

FIG. 2 illustrates a schematic diagram of one embodiment of the proposed water heating solar model.

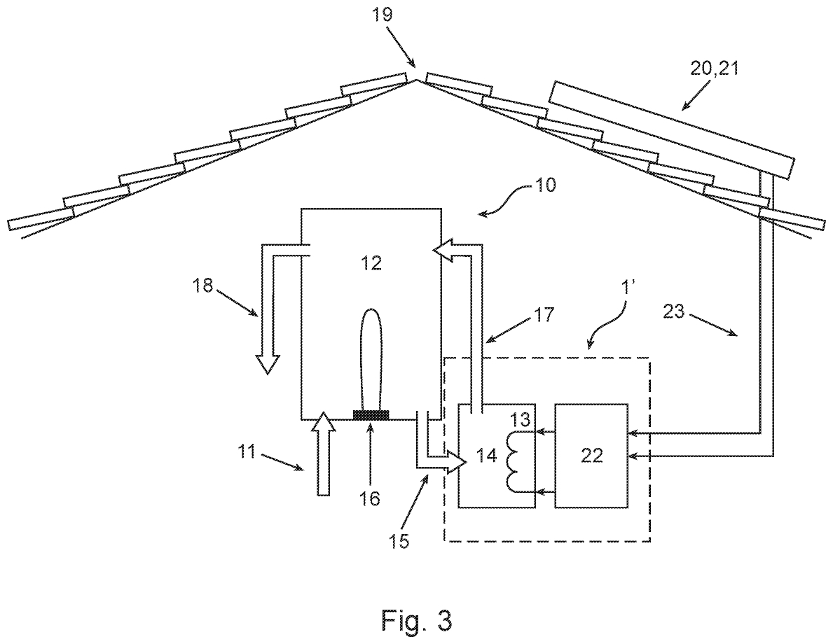

FIG. 3 illustrates a schematic diagram of one embodiment of the proposed water heating system.

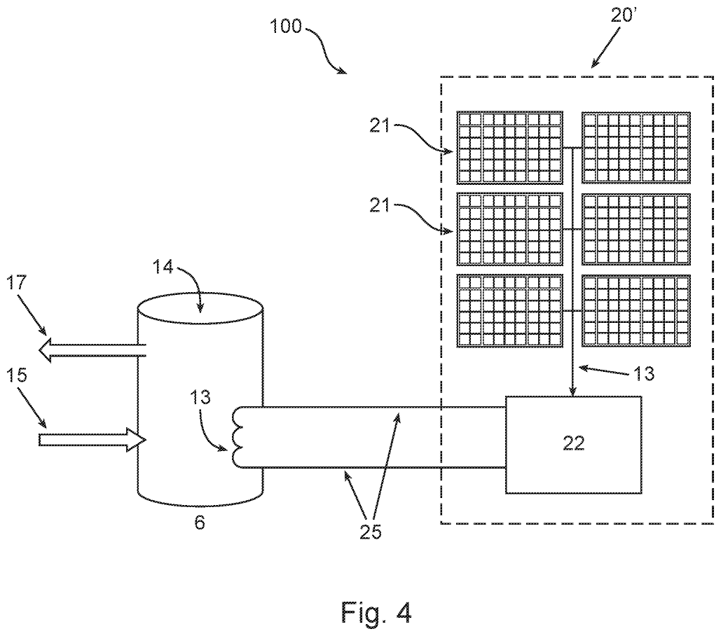

FIG. 4 illustrates another arrangement of the proposed module, in more detail.

### DETAILED DESCRIPTION OF THE INVENTION

FIG. 1 (prior art) has been described in the background section of the description.

FIG. 2 schematically illustrates one embodiment of the proposed water heating solar module (1). The module 1 may serve as a stand-alone unit. In this embodiment, the module 1 is designed to form part of a water heating system (one example will be shown in FIG. 3). In another example, module 1 may replace the solar collectors SC of FIG. 1, thereby turning the old solar system SS into an upgraded system.

The module 1 comprises its power supply unit 2 adapted to receive and then process electric energy from an external solar cell (for example a photovoltaic cell, not shown) via electric wires 9. As already mentioned, the solar cell is a device for converting solar energy into electrical energy.

Wires 9 may form a DC circuit between the power supply 2 and the solar cell. The power supply unit 2 is electrically connected to a first heating element 3 installed in a vessel 4. When in operation, the power supply 2 energizes the heating element 3 for heating water or other fluid in the vessel 4. Power supply 2 may feed the heating element with DC. Alternatively it may be capable of converting DC to AC, so as to feed the heating element 3 by AC. The first heating element 3 may be a regular heating element, but in any case it may be called a solar/photoelectric/photovoltaic heating element, since it is fed by electricity produced from solar energy.

The vessel 4 may be shaped as a tank, a pipe, a pipe assembly or have any other suitable shape. The vessel 4 has a water inlet 5 at the bottom portion 6, and a water outlet 7 at the top portion 8 of the vessel 4.

The vessel 4 is preferably designed so as to be placed close to a main water tank in a water heating system, with its bottom portion positioned not higher than the bottom portion of the main water tank (not shown here). Preferably, the vessel is designed so as to be placed under a main water tank of the water heating system. That means that the module should usually suit to crowded spaces and thus may need to have a modest volume and an arbitrary shape dictated by the available space.

Optionally, the water inlet 5 and water outlet 7 may have respective pipes 50 and 70. In a stand-alone module, the pipe 50 may be a cold water inlet pipe, and the pipe 70 —a hot water outlet pipe.

In the proposed version of the module, intended for incorporating it in a water heating system, the pipes 50, 70 will serve as water circulation pipes.

However, the module 1 may be sold without pipes 50, 70 and be provided with them at the site. For example, the pipes 50, 70 may be flexible water hoses.

FIG. 3 schematically shows one exemplary embodiment 10 of the proposed water heating system comprising two water tanks 12 and 14, which are both situated inside a building 19 (for example, under a roof, in a basement, on stares, etc.).

The main water tank (boiler) 12 is fed by cold water from a water supply net via an inlet pipe 11. The hot water ready for use is delivered from the boiler 12 via an outlet pipe 18. Water valves are not shown. The main tank (boiler) 12 is provided with a main electric heating element 16 for heating water in the boiler.

The proposed module 1′, comprising a vessel (an additional water tank) 14 to be preheated by solar energy, is positioned almost completely under the bottom line of the boiler (main water tank) 12. The module 1′ is similar to the module 1 of FIG. 2, so similar elements of the module are marked with similar numbers.

The vessel 14 of the module 1′ is in flow communication with the boiler 12 via two water circulation pipes: a cold water circulation pipe 15 and a hot water circulation pipe 17. The vessel 14 is provided with a heating element 13 which is a photoelectric heater. More specifically, the element 13 is an electric heater which is electrically connected to a power supply 22 unit. The unit 22 is fed via electric wires 23 by a photoelectric circuit (such as photovoltaic system of cells) 20 positioned outside the building 19, for example on its roof.

The photovoltaic system 20 receives solar radiation and converts it to electric energy. The obtained energy is applied, via electric wires, to the power supply 22 which processes it and feeds the heating element 13 installed in the water tank (vessel) 14.

Water level sensors, water valves and electric current switches are not shown in this drawing.

The inlet water pipe 11 keeps the tank 12 full with water. Whenever a user opens the outlet pipe 18 to use some hot water, the inlet pipe 11 fulfills the tank 12 with cold water. The water level regulation scheme is not shown. Since the tank 12 communicates with the tank 14 (vessel of the module 1′), part of the cold water from the bottom portion of tank 12 will flow to the bottom portion of the tank 14 via pipe 15 and will be heated there by the photoelectric heater 13. The heated water will go up and, from the hot upper portion of the vessel 14, will raise via pipe 17 to the upper portion of the tank 12. Tank 12 may also heat the water there-inside, using its own electric heater 16. However, when there is enough sun, power of the photoelectric heater 18 may be sufficient to heat all the water in the system. In such cases, the main electric heater 16 may be switched OFF by the user or automatically, and the water tank 12 may be heated just owing to the water circulation with the vessel 14.

In periods when there is no solar radiation, the main heating element 16 will heat the water in the main tank 12. The module 1′ will not affect operation of the system 10.

FIG. 4 shows a slightly different arrangement 100 of the proposed water heating solar module Similar elements are marked with similar numbers. In the embodiment 100, the vessel 14 is heated by the aid of the photoelectric system schematically marked 20′. The photoelectric system 20′ includes an array of photovoltaic cells 21, connected to a DC/DC MPPT controller 22 which serves as a power supply unit for the heating element 13. The controller 22 may be positioned close to the cells 21, but preferably it is remote from the cells (for example, located in the premises) and connected with the cells by electric wires 23. It goes without saying that the photovoltaic cells 21 are totally different from the solar collector SC shown in FIG. 1: each of them is designed to convert solar energy into electric energy. The electric energy produced by the cells 21 is received by the power supply 22 and fed to the heating element 13 of the module via electric contacts/wires 25.

The MPPT (Maximum power point tracking) controller of the power supply 22 reflects optimal impedance of the photovoltaic system in order to gain maximum efficiency of the power supply.

It should be noted that though the module and the system were described for heating water, they may be used for heating various fluids, including liquids and gases. Therefore the claims should be understood in the broad meaning, covering the claimed module and system for heating fluids—gases or liquids like water, oil, etc.

While the invention has been described with reference to a specific implementation, it should be appreciated that other embodiments/versions of the inventive technique may be proposed and should be considered part of the invention whenever defined by the claims which follow.

1. A water heating system, the system comprising:
a water heating solar module connected to a boiler the water heating solar module comprising:
a vessel having a water inlet adapted for receiving water from the boiler, a water outlet, adapted for delivering water to the boiler,
a first heating element installed in the vessel, and
a power supply for feeding the first heating element with electric power produced from solar energy.

2. (canceled)

3. (canceled)

4. The water heating system of claim 1, wherein the power supply comprises a Maximum Power Point Tracking circuit MPPT adapted for collecting electric power from the photoelectric device, and for feeding the first heating element with the collected electric power.

5. The water heating system of claim 1, wherein the power supply is designed so as to receive DC electric power from said one or more photovoltaic cells, and to feed the first heating element with DC electric power.

6. The water heating system of claim 1, wherein the power supply is adapted to convert DC to AC so as to feed the first heating element with AC electric power.

7. (canceled)

8. (canceled)

9. The water heating system of claim 1, wherein
the module is positioned so that the vessel's lower portion is not higher than the boiler's bottom portion,
the boiler is equipped with a second heating element,
the boiler is provided with the following four pipes:
an inlet cold water pipe,
an outlet hot water pipe,
a cold water circulation pipe connecting a bottom portion of the boiler with the water inlet of the vessel,
a hot water circulation pipe connecting the water outlet of the vessel with a top portion of the boiler.

10. The water heating system of claim 1, wherein the power supply is connected with a photoelectric device via electrical wires.

11. The water heating system of claim 1, wherein
both the vessel of the module and the boiler are located within a premises,
a photoelectric system is installed outside the premises and connected via electric wires to the power supply.

12. (canceled)

13. (canceled)

14. (canceled)

15. A water heating system, the system comprising
a solar module and an electric boiler having an outflow pipe, wherein the system circulates water between the solar module and the electric boiler when there is no water flowing out the outflow pipe.

16. The water heating system of claim 15, wherein the solar module comprises a first set of electrical circuits and the electric boiler comprises a second set of electrical circuits wherein the first set of electrical circuits and the second set of electrical circuits are different and wherein the first set of electrical circuits is off when the second set of electrical circuits is on.

17. The water heating system of claim 15, wherein the solar module comprises a first set of electrical circuits and the electric boiler comprises a second set of electrical circuits wherein the first set of electrical circuits and the second set of electrical circuits are different and wherein the first set of electrical circuits is on when the second set of electrical circuits is off.

18. The water heating system of claim 15, wherein the solar module and electric boiler are fluidly connected by at least two water circulation pipes.

19. The water heating system of claim 15, wherein the solar module further comprises a cold-water circulation pipe for connecting the water intel of the vessel with the boiler, and a hot-water circulation pipe for connecting the water outlet of the vessel with the boiler.

20. The water heating system of claim 15, wherein the solar module is configured to be heated with solar energy.

21. The water heating system of claim 15, wherein the solar module comprises a first tank and the electric boiler comprises a second tank, wherein the first tank and the second tank are configured to move cold water from the second tank to the first tank, wherein the first tank is configured to heat the water, and wherein the first tank and the second tank are configured to move heated water from the first tank to the second tank.

22. The water heating system of claim 15, wherein when water is heated in the solar module it is not heated in the electric boiler.

23. A water heating system, the system comprising
a solar module comprising a first tank having a first heating element, and a hot outflow pipe connected to the second tank; and
an electric boiler comprising a second tank having a second heating element, a cold outflow pipe connected to the first tank, an inlet cold water pipe, and an outlet hot water pipe.

24. The water heating system of claim 23, wherein only the second tank supplies hot water to a user.

25. The water heating system of claim 23, wherein water in the first tank is heated by circulating the water out of the second tank, into the first tank, and back into the second tank.

26. The water heating system of claim 23, wherein the solar module remains in fluid communication with the electric boiler when the solar module is inactive.

27. The water heating system of claim 23, wherein when solar radiation is insufficient for heating water, the solar module is inactive and has no effect on the system.
